(19) United States
(12) Patent Application Publication
(10) Pub. No.: US 2025/0119006 A1
(43) Pub. Date: Apr. 10, 2025

(54) Collar for Securing Housing of Electric Rotor to Rotor Shaft

(71) Applicant: Newfrey LLC, New Britain, CT (US)

(72) Inventors: Oday Amer SAFRY, Farmington Hills, MI (US); Andrew C. HEIDACKER, Commerce Township, MI (US); Anthony SCHEER, Ridgefield, CT (US); Donald K. BLAESS, Cresco, IA (US); Terry G. JACOBS, Portland, IN (US); Tien T. DIEP, West Bloomfield Township, MI (US)

(73) Assignee: Newfrey LLC, New Britain, CT (US)

(21) Appl. No.: 18/904,873

(22) Filed: Oct. 2, 2024

Related U.S. Application Data
(60) Provisional application No. 63/587,854, filed on Oct. 4, 2023.

(51) Int. Cl. H02K 1/26; H02K 1/28

(52) U.S. Cl. CPC H02K 1/26; H02K 1/28

(57) ABSTRACT

An electric rotor includes a shaft, windings, a first end cap, a second end cap, and a collar. The shaft includes a head and a shank. The windings extend around the shank of the shaft. The first end cap has a first side engaging a first end of the windings and a second side engaging the head of the shaft. The second end cap has a first side engaging a second end of the windings opposite of the first end. The collar is crimped to the shank of the shaft and engages a second side of the second end cap opposite of the first side of the second end cap such that (i) the windings are clamped between the first and second end caps and (ii) the shaft, the windings, the first and second end caps, and the collar rotate together as a single unit.

### CROSS-REFERENCE TO RELATED APPLICATIONS

This application claims the benefit of U.S. Provisional Application No. 63/587,854, filed on Oct. 4, 2023. The entire disclosure of the above application is incorporated herein by reference.

### FIELD

The present disclosure relates to collars for securing a housing of an electric rotor to a shaft of the electric rotor.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An electric rotor is a rotor of an electric motor, electric generator, or alternator. An electric rotor typically includes a shaft, windings disposed on the shaft, end caps disposed on opposite sides of the windings, and a collar disposed on the shaft outboard of one of the end caps. The shaft includes a head and a shank, and the head prevents the other one of the end caps from moving axially along the length of the shaft away from the windings. The collar holds the one end cap in position on the shaft and thereby clamps the windings between the end caps. In turn, the entire rotor, including the shaft, the windings, the end caps, and the collar, rotate together as a single unit.

### SUMMARY

An example of an electric rotor according to the present disclosure includes a shaft, windings, a first end cap, a second end cap, and a collar. The shaft includes a head and a shank. The windings extend around the shank of the shaft. The first end cap has a first side engaging a first end of the windings and a second side engaging the head of the shaft. The second end cap has a first side engaging a second end of the windings opposite of the first end. The collar is crimped to the shank of the shaft and engages a second side of the second end cap opposite of the first side of the second end cap such that (i) the windings are clamped between the first and second end caps and (ii) the shaft, the windings, the first and second end caps, and the collar rotate together as a single unit. A portion of the shank to which the collar is crimped is not slotted relative to the rest of the shank.

In one aspect, the collar includes serrations that penetrate the second side of the second end cap.

In one aspect, the shaft has a tapered outer radial surface and the collar has a tapered inner radial surface that engages the tapered outer radial surface of the shaft.

In one aspect, the tapered outer radial surface of the shaft is tapered inward in a direction toward the head of the shaft, and the tapered inner radial surface of the collar is tapered inward in the same direction.

In one aspect, the collar includes an annular body and a lip projecting radially from the annular body.

In one aspect, the collar includes an annular body and a ramped base projecting radially from the annular body.

Another example of an electric rotor according to the present disclosure includes a shaft, windings, a first end cap, a second end cap, and a collar. The shaft includes a head and a shank. The windings extend around the shank of the shaft. The first end cap has a first side engaging a first end of the windings and a second side engaging the head of the shaft. The second end cap has a first side engaging a second end of the windings opposite of the first end. The collar is crimped to the shank of the shaft and penetrates a second side of the second end cap opposite of the first side of the second end cap such that (i) the windings are clamped between the first and second end caps and (ii) the shaft, the windings, the first and second end caps, and the collar rotate together as a single unit.

A method of assembling an electric rotor according to the present disclosure includes sliding a first end cap along a shank of a shaft until the first end cap engages a head of the shaft, sliding windings onto the shaft, sliding a second end cap onto the shaft such that the windings are disposed between the first and second end caps, sliding a collar onto the shaft, and crimping the collar onto the shaft and pressing the collar against the second end cap in a single operation such that (i) the windings are clamped between the first and second end caps and (ii) the shaft, the windings, the first and second end caps, and the collar rotate together as a single unit.

In one aspect, the method further includes both crimping the collar onto the shaft and pressing the collar against the second end cap by moving a crimping tool in a single direction.

In one aspect, the single direction is a radial direction relative to the shaft.

In one aspect, the single direction is along a longitudinal axis of the shaft.

In one aspect, the method further includes applying a diametrical load to the collar to engage a tapered inner radial surface of the collar with a tapered outer radial surface of the shaft and thereby both crimp the collar onto the shaft and press the collar against the second end cap.

In one aspect, pressing the collar against the second end cap causes serrations on an axial end of the collar to penetrate the second end cap.

In one aspect, the collar includes an annular body and a lip projecting radially from the annular body, and the method further includes applying an axial load to the annular body to both crimp the collar onto the shaft and press the collar against the second end cap.

In one aspect, an angle between the lip and the annular body is obtuse before the collar is crimped, and the method further includes applying the axial load to an axial end of the annular body with a moveable sleeve of a crimping tool while engaging an outer edge of the lip with a fixed sleeve of the crimping tool to decease the angle between the lip and the annular body.

In one aspect, the collar includes an annular body and a lip projecting radially from the annular body, and the method further includes applying a diametrical load to the lip to both crimp the collar onto the shaft and press the collar against the second end cap.

In one aspect, an angle between the lip and the annular body is acute before the collar is crimped, and the method further includes receiving the annular body in an annular pocket in a moveable sleeve of a crimping tool while applying the diametrical load to an outer edge of the lip with the moveable sleeve to increase the angle between the lip and the annular body.

In one aspect, the collar includes an annular body and a ramped base projecting radially from the annular body, and the method further includes applying both an axial load and a diametrical load to the collar to both crimp the collar onto the shaft and press the collar against the second end cap.

In one aspect, the method further includes engaging a tapered inner surface of a crimping tool with an outer radial surface of the annular body of the collar while moving the crimping tool in an axial direction to apply the axial and diametrical loads to the collar and thereby deform the collar radially inward toward the shaft and axially toward the second end cap.

In one aspect, the method further includes moving the crimping tool in the axial direction until a tapered end surface of the crimping tool engages the ramped base of the collar. A taper angle of the tapered end surface of the crimping tool matches a taper angle of the ramped base of the collar.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic diagram of an example of an electric rotor assembly including a shaft, a housing, windings, and a collar securing the housing to the shaft according to the principles of the present disclosure;

FIG. 2 is a perspective view of an example of the collar of FIG. 1 according to the principles of the present disclosure;

FIG. 3 is a perspective view of a portion of an example of the shaft of FIG. 1 according to the principles of the present disclosure;

FIG. 4 is a side view of the electric rotor assembly of FIG. 1 including another example of the shaft according to the principles of the present disclosure, with the collar being position on an end of the shaft;

FIG. 5 is an enlarged view of a portion of the electric rotor assembly of FIG. 4;

FIG. 6 is a side view of the electric rotor assembly of FIG. 4 with the collar position further down the shaft due to the force of gravity;

FIG. 7 is an enlarged view of a portion of the electric rotor assembly of FIG. 6;

FIG. 8 is a side view of the electric rotor assembly of FIG. 1 with the collar crimped onto the shaft;

FIG. 9 is an enlarged view of a portion of the electric rotor assembly of FIG. 8;

FIG. 10 is a section view of the electric rotor assembly of FIG. 4;

FIG. 11 is a section view of the electric rotor assembly of FIG. 6;

FIG. 12 is a section view of the electric rotor assembly of FIG. 8;

FIG. 13 is a top view of the collar of FIG. 2;

FIG. 14 is a side view of the collar of FIG. 2;

FIG. 15 is a bottom view of the collar of FIG. 2;

FIG. 16 is a perspective view of another example of the collar of FIG. 1, with the collar shown in its crimped state;

FIGS. 17 through 19 are section views illustrating one method of crimping a collar onto a shaft to form the crimped collar of FIG. 16

FIGS. 20 through 25 are section views illustrating another method of crimping a collar onto a shaft to form the crimped collar of FIG. 16;

FIG. 26 is a section view of another example of an electric rotor assembly including a shaft, a housing, windings, and a collar according to the present disclosure, with a tool crimping the collar onto the shaft;

FIG. 27 is an enlarged view of a portion of the electric rotor assembly of FIG. 26; and

FIGS. 28 through 35 are section views illustrating the tool crimping the collar onto the shaft of the electric rotor assembly of FIG. 26

In the drawings, reference numbers may be reused to identify similar and/or identical elements.

### DETAILED DESCRIPTION

As discussed above, an electric rotor typically includes a shaft, windings disposed on the shaft, end caps disposed on opposite sides of the windings, and a collar or nut that holds one of the end caps in place and thereby clamps the windings between the end caps. In one example, a nut is threaded onto the shaft. Threading the nut onto the shaft is a time-consuming operation, and the nut may become unthreaded from the shaft. In another example, a collar is installed by pressing one end cap along the axis of the shaft toward the other end cap to compress the windings therebetween, diametrically crimping the collar into an annular slot in the shaft to hold the one end cap in position, and releasing the one end cap. The annular slot is positioned along the length of the shaft so that the windings are compressed between the end caps when the one end cap is released. This process requires several operations and is therefore time-consuming. In addition, this process requires a precise assembly process to ensure that the collar sits within the annular slot, which adds cost and complexity to installation tooling.

A collar according to the present disclosure can be crimped to a shaft and pressed against one of the end caps in a single operation by moving installation tooling in a single direction (e.g., along the axis of the shaft) instead of two directions as described above, which reduces the number of operations and time required to assemble an electric rotor. In one example, the collar has a tapered inner radial surface that engages a tapered outer radial surface of the shaft as a diametrical load is applied to the collar. The engagement between the tapered surfaces of the collar and the shaft holds the collar in position along the length of the shaft and causes the collar to deform axially and press against one of the end caps. This engagement provides a robust assembly process which does not require precise tooling or an annular slot in the shaft. In one aspect, an end or bottom surface of the collar has serrations that bite into the one end cap and thereby prevent the one end cap from rotating relative to the shaft.

In another example, the collar incudes an annular body and a lip projecting radially from the annular body, and the collar is crimped to the shaft by either applying an axial load to the annular body or applying a diametrical load to the lip. In either case, the annular body deforms and thereby develops a tapered inner radial surface that conforms to a tapered outer radial surface of the shaft, and the lip deforms toward one of the end caps such that a bottom surface of the lip presses against the one end cap.

In yet another example, the collar includes an annular body and a ramped base projecting radially from the annular body, and the collar is crimped to the shaft by applying both an axial load and a diametrical load to the collar while the installation tooling moves in only one direction along the axis of the shaft. An outer diameter of the annular body of the collar is greater than an inner diameter of a crimping tool for crimping the collar, and the crimping tool has a tapered inner radial surface. When the crimping tool is positioned around the collar and moves axially toward its ramped base, the tapered inner radial surface of the crimping tool engages to the collar and thereby causes the collar to deform radially inward toward the shaft and axially toward one of the end caps. In turn, the ramped base of the collar presses against the one end cap.

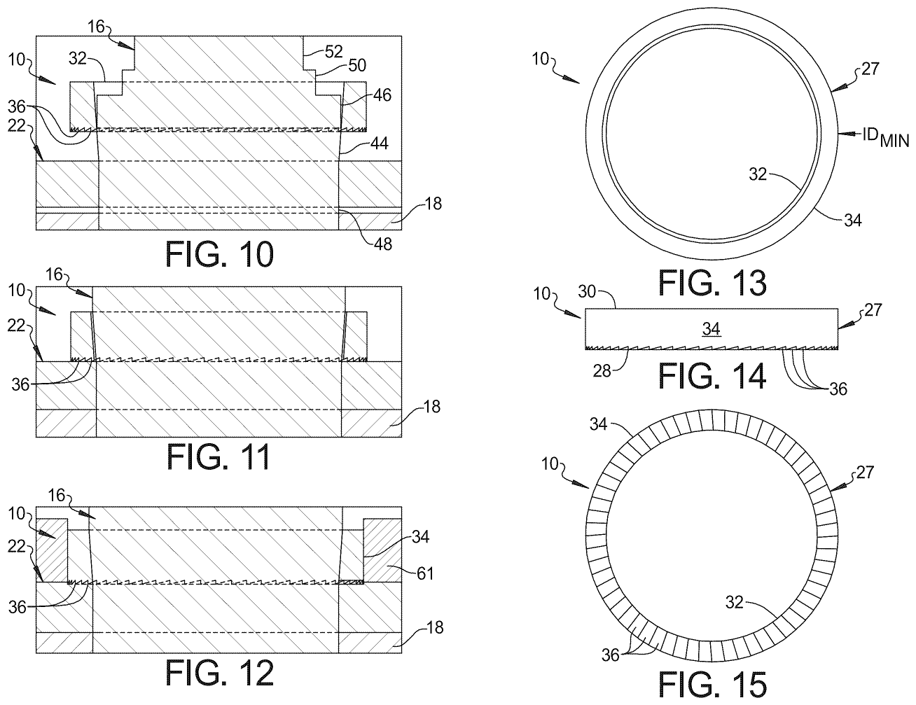

Referring to FIGS. 1 through 15, the present disclosure generally relates to a collar 10 for securing a housing 12 of an electric rotor 14 to a shaft 16 of the rotor 14 and thereby securing windings 18 within the housing 12 and/or to the shaft 16. In the example shown, the housing 12 includes a cylindrical body 20 surrounding the windings 18 and a pair of end caps 22 covering opposite ends of the windings 18. However, in various implementations, the cylindrical body 20 may be omitted.

The rotor 14 may be a squirrel-cage rotor, a wound rotor, a salient pole rotor, or a non-salient rotor. The shaft 16 includes a head 24 and a shank 26. The collar 10 is fixed to the shank 26 of the shaft 16 and to one of the end caps 22 of the housing 12 such that the housing 12 rotates with the shaft 16. The windings 18 may include a metal (e.g., steel) core with wire wound around the metal core, or the windings 18 may be replaced with laminates and permanent magnets such as in a permanent magnet motor.

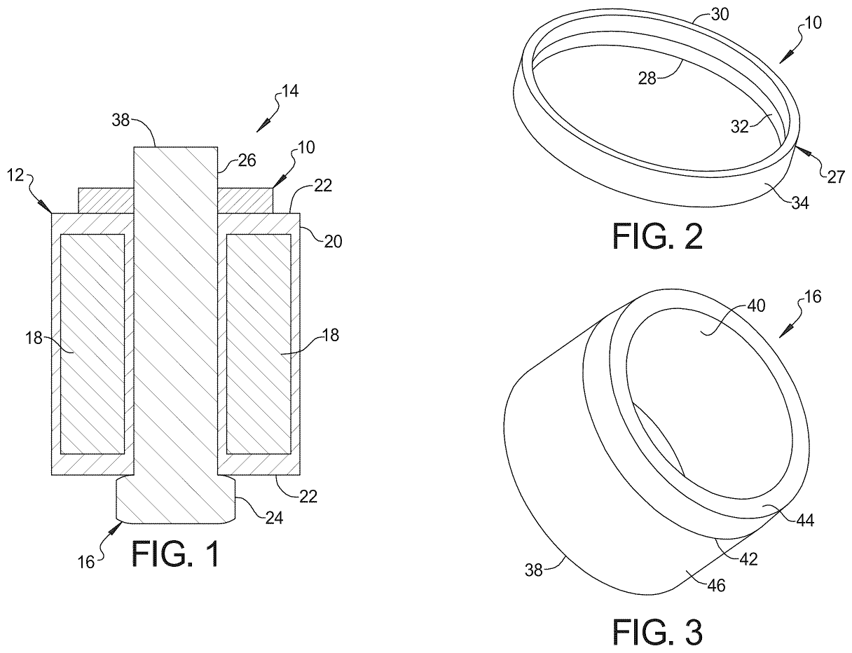

As best shown in FIGS. 2, 13, and 14, one example of the collar 10 has an annular body 27 with an inboard end 28, an outboard end 30, an inner radial surface 32, and an outer radial surface 34. The inboard end 28 of the collar 10 has serrations 36 for biting into the one end cap 22 of the housing 12 to which the collar 10 is fixed. As best shown in FIG. 5, the inner radial surface 32 of the collar 10 is tapered inward in a direction from the outboard end 30 of the collar 10 to the inboard end 28 of the collar 10. The inner radial surface 32 of the collar 10 is tapered at an angle A1 (e.g., 5 degrees).

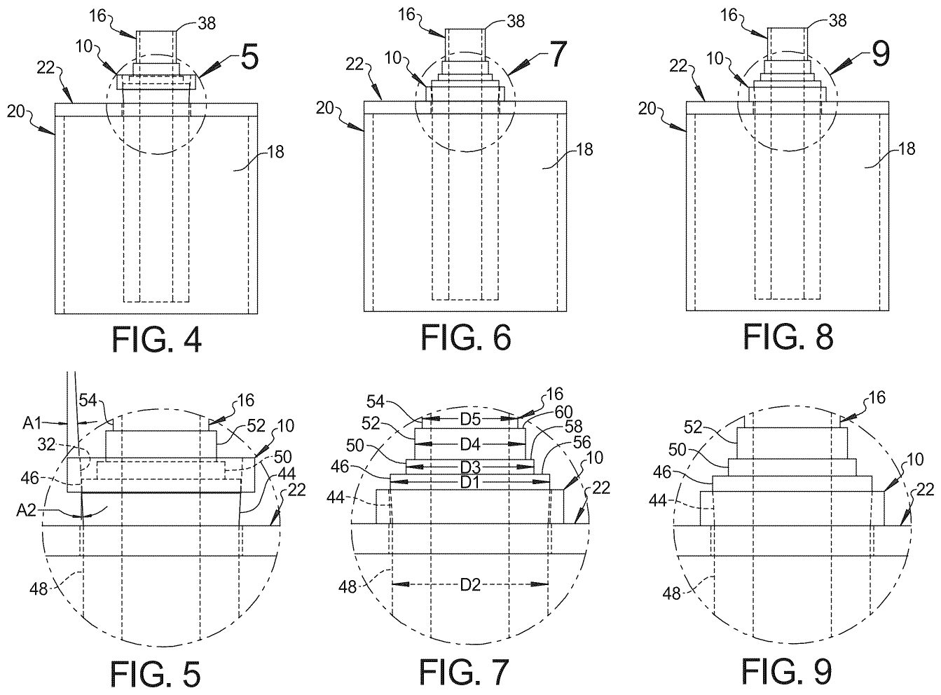

FIG. 3 shows an example of a portion of the shank 26 of the shaft 16, and FIGS. 4 through 12 show another example of a portion of the shank 26. In both examples, the shaft 16 has a distal end 38, an inner radial surface 40, and an outer radial surface 42. The outer radial surface 42 of the shaft 16 includes a tapered portion 44 and a first non-tapered portion 46. As best shown in FIG. 5, the tapered portion 44 of the outer radial surface 42 is tapered inward in a direction from the distal end 38 to the first non-tapered portion 46. The tapered portion 44 is tapered at an angle A2 that may be equal to the angle A1 of the collar taper. As shown in FIG. 7, the first non-tapered portion 46 has a first diameter D1.

The example of the shaft 16 shown in FIGS. 4 through 12 further includes a second non-tapered portion 48, a third non-tapered portion 50, a fourth non-tapered portion 52, and a fifth non-tapered portion 54. The first and second non-tapered portions 46 and 48 are disposed on opposite sides of the tapered portion 44. The first, third, fourth, and fifth non-tapered portions 46, 50, 52, and 54 are disposed between the distal end 38 of the shaft 16 and the tapered portion 44 of the shaft 16. The second non-tapered portion 48 has a second diameter D2 that is less than the first diameter D1 of the first non-tapered portion 46. In this regard, the tapered portion 44 provides a transition between the first and second non-tapered portions 46 and 48.

The third non-tapered portion 50 has a third diameter D3 that is less than the first diameter D1 of the first non-tapered portion 46, and a step or ledge 56 is defined between the first and third non-tapered portions 46 and 50. The fourth non-tapered portion 52 has a fourth diameter D4 that is less than the third diameter D3 of the third non-tapered portion 50, and a step or ledge 58 is defined between the third and fourth non-tapered portions 48 and 50. The fifth non-tapered portion 54 has a fifth diameter D5 that is less than the fourth diameter D4 of the fourth non-tapered portion 52, and a step or ledge 60 is defined between the fourth and fifth non-tapered portions 52 and 54.

Referring again to FIG. 1, to assemble the rotor 14, one of the end caps 22 is slid over the distal end 38 of the shaft 16 and along the shank 26 of the shaft 16 until it engages the head 24 of the shaft 16. The windings 18 are then slid onto the shaft 16, and then the other one of the end caps 22 is slid onto the shaft 16 such that the windings 18 are disposed between the end caps 22. Finally, the collar 10 is slid over the distal end 38 of the shaft 16 and is crimped onto the shaft 16 and the end cap 22 adjacent to the distal end 38 such that the windings 18 are clamped between the end caps 22, and the entire rotor 14, including the shaft 16, the housing 12, and the collar 10, rotates as one unit.

FIGS. 4 through 12 illustrate the process of assembling the collar 10 to the shaft 16 and thereby securing the windings 18 between the end caps 22. In FIGS. 4, 5, and 10, the collar 10 is slid over the distal end 38 of the shaft 16 and positioned around the first non-tapered portion 46 of the shaft 16 by hand. The minimum inner diameter IDmin (FIG. 13) of the collar 10 is greater than the maximum outer diameter of the shaft 16 (e.g., the first diameter D1 of the first non-tapered portion 46) so that the collar 10 can be slid onto the shaft 16 by hand. In FIGS. 6, 7, and 11, the assembler releases the collar 10, and therefore the collar 10 translates from the first non-tapered portion 46 of the shaft 16 to the tapered portion 44 of the shaft 16 due to the force of gravity.

In FIGS. 8, 9, and 12, a crimping tool 61 has been used to apply a diametrical load to the outer radial surface 34 of the collar 10 and thereby crimp the collar 10 onto the shaft 16. As the crimping tool 61 applies the diametrical load to the collar 10, the crimping tool 61 deforms the collar 10 radially inward to reduce the inner diameter of the collar 10 and thereby eliminate any gap between the collar 10 and the shaft 16. In turn, the tapered inner radial surface 32 of the collar 10 engages the tapered portion 44 of the shaft 16. In addition, the crimping tool 61 deforms the collar 10 in a direction toward the housing 12, and the serrations 36 on the inboard end 28 of the collar 10 penetrate the one end cap 22 of the housing 12 and thereby bind the collar 10 to the one end cap 22.

The penetration of the serrations 36 on the collar 10 into the one end cap 22 prevents the one end cap 22 from rotating relative to the shaft 16, and thereby ensures that the windings 18 and the shaft 16 rotate together as one unit. In various implementations, the windings 18 may be keyed to the shaft 16 independent of the collar 10 to prevent relative rotation therebetween. In these implementations, the collar 10 still prevents the ends caps 22 from becoming loose and thereby prevents rattling of the end caps 22 and damage to the end caps 22.

The engagement between the tapered inner radial surface 32 of the collar 10 and the tapered portion 44 of the shaft 16 locks the collar 10 in position on the shaft 16 and thereby prevents separation of the collar 10 from the housing 12. In addition, the engagement between these tapered surfaces drives the collar 10 into the one end cap 22, which applies a clamping load on the windings 18 and embeds the serrations 36. The inner perimeter of the crimping tool 61 that engages the collar 10 may have a circular or hexagonal shape. The crimping tool 61 may be a hydraulic crimping tool such as iGeelee® Hydraulic Hose Crimper or an electric crimping tool such as DeWalt® 20V Pro Press Tool.

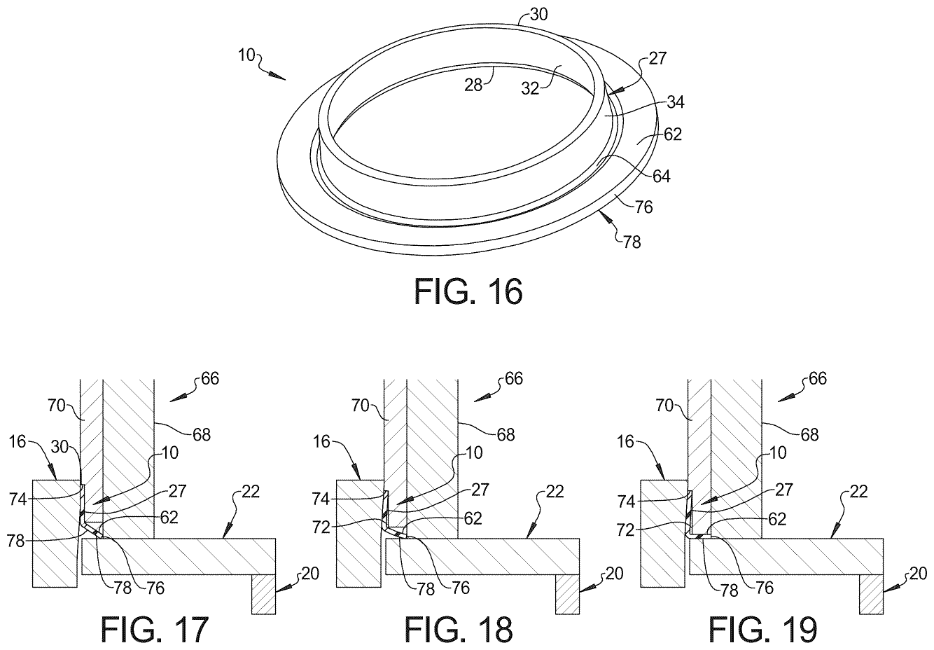

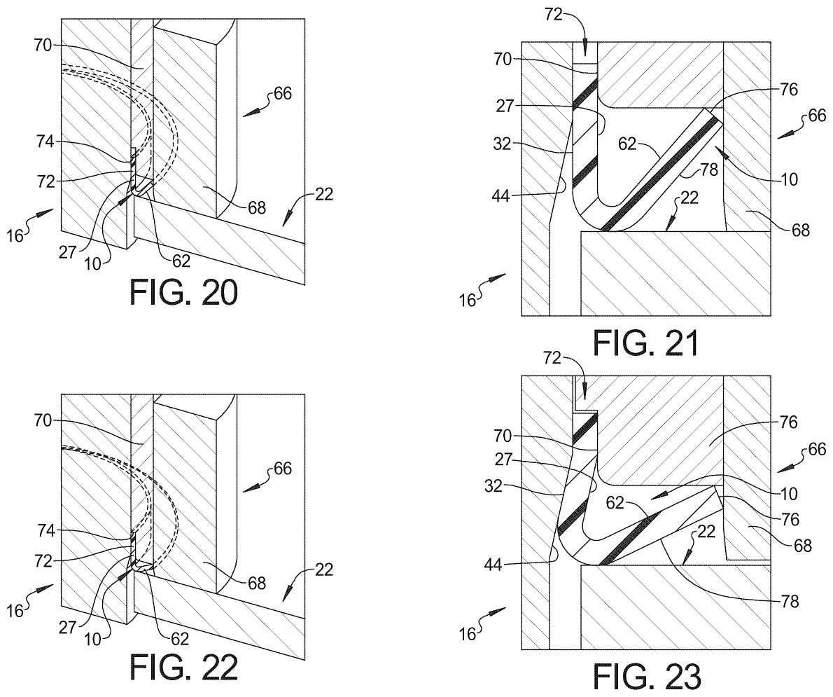

Referring to FIGS. 16 through 25, another example of the collar 10 is illustrated. FIG. 16 shows the collar 10 in its crimped state, FIGS. 17 through 19 show one way of crimping the collar 10 to the shaft 16, and FIGS. 20 through 25 show another way of crimping the collar 10 to the shaft 16. As with the previous example, the collar 10 shown in FIG. 16 has the annular body 27 with the inboard end 28, the outboard end 30, the inner radial surface 32, and the outer radial surface 34. In addition, the inner radial surface 32 of the collar 10 is tapered inward in a direction from the outboard end 30 of the collar 10 to the inboard end 28 of the collar 10.

In contrast to the previous example, the collar 10 shown in FIG. 16 includes a lip 62 projecting radially from the annular body 27 at the inboard end 28 of the collar 10, and a fillet 64 disposed at the interface between the outer radial surface 34 of the annular body 27 and the lip 62. Also, in contrast to the previous example, the collar 10 shown in FIG. 16 is crimped to the shaft 16 by applying an axial load to the collar 10 instead of applying a diametrical load. The magnitude of the axial load required to crimp the collar 10 of FIG. 16 may be significantly less than the magnitude of the diametrical load required to crimp the collar 10 of the previous example.

FIGS. 17 through 19 show how the collar 10 of FIG. 16 may be crimped to the shaft 16 by applying an axial load to the outboard end 30 of the collar 10. FIG. 17 shows the collar 10 in its pre-crimped state, with the collar 10 slid over the distal end 38 of the shaft 16 and resting on one end cap 22, and a crimping tool 66 surrounding the collar 10. When the collar 10 is in its pre-crimped state, the lip 62 forms an obtuse angle with the annular body 27. The crimping tool 66 includes a fixed sleeve 68 and a moveable sleeve 70 that is axially moveable relative to the fixed sleeve 68. The moveable sleeve 70 defines an annular pocket 72 configured to receive the annular body 27 of the collar 10, and a shoulder 74 configured to engage the outboard end 30 of the collar 10.

In FIG. 17, the shoulder 74 of the moveable sleeve 70 contacts the outboard end 30 of the collar 10 and the fixed sleeve 68 contacts an outer edge 76 of the lip 62 of the collar 10. In FIG. 18, the moveable sleeve 70 is moved downward relative to the fixed sleeve 68. As the moveable sleeve 70 moves downward, the shoulder 74 of the moveable sleeve 70 pushes the outboard end 30 of the collar 10 downward. As this occurs, the engagement between the outer edge 76 of the lip 62 and the fixed sleeve 68 prevents the lip 62 from moving radially outward, and the engagement between the outer edge 76 and the one end cap 22 prevents the lip 62 from moving downward. Thus, the lip 62 deflects upward and the angle between the lip 62 and the annular body 27 decreases. In addition, the inboard end 28 of the annular body 27 begins to deflect radially inward to conform to the tapered portion 44 of the shaft 16.

In FIG. 19, the moveable sleeve 70 is moved further downward relative to the fixed sleeve 68. As a result, the lip 62 of the collar 10 has further deflected upward, and the inboard end 28 of the annular body 27 of the collar 10 has further deflected radially inward. In turn, the lip 62 forms an acute angle with the annular body 27 adjacent to the fillet 64, and the lip 62 forms a right angle, or nearly a right angle, with the annular body 27 adjacent to the outboard end 30. As a result, the taper angle of the inner radial surface 32 of the collar 10 matches the taper angle of the tapered portion 44 of the shaft 16. Thus, as in the previous example, the engagement between these tapered surfaces prevents separation of the collar 10 from the housing 12. Also, a bottom surface 78 of the lip 62 may have the serrations that penetrate the one end cap 22 and thereby prevent separation of the collar 10 from the housing 12 as in the previous example.

FIGS. 20 through 25 show how the collar 10 of FIG. 16 may be crimped to the shaft 16 by applying an axial load to the outer edge 76 of the lip 62 of the collar 10. FIGS. 20 and 21 show the collar 10 in its pre-crimped state, with the collar 10 slid over the distal end 38 of the shaft 16 and resting on one end cap 22, and the crimping tool 66 surrounding the collar 10. In contrast to the example discussed with reference to FIGS. 17 through 19, when the collar 10 is in its pre-crimped state, the lip 62 forms an acute angle with the annular body 27.

In FIGS. 20 and 21, the annular pocket 72 of the moveable sleeve 70 begins to receive the annular body 27 of the collar 10, and the fixed and moveable sleeves 68 and 70 contact the outer edge 76 of the lip 62. In FIGS. 22 and 23, the moveable sleeve 70 is moved downward relative to the fixed sleeve 68. As the moveable sleeve 70 moves downward, the moveable sleeve 70 deforms the lip 62 downward and away from the annular body 27. In addition, the engagement between the moveable sleeves 68 and 70 and the outer edge 76 of the lip 62 causes the inboard end 28 of the annular body 27 to deflect radially inward such that the inner radial surface 32 of the collar 10 conforms to the tapered portion 44 of the shaft 16.

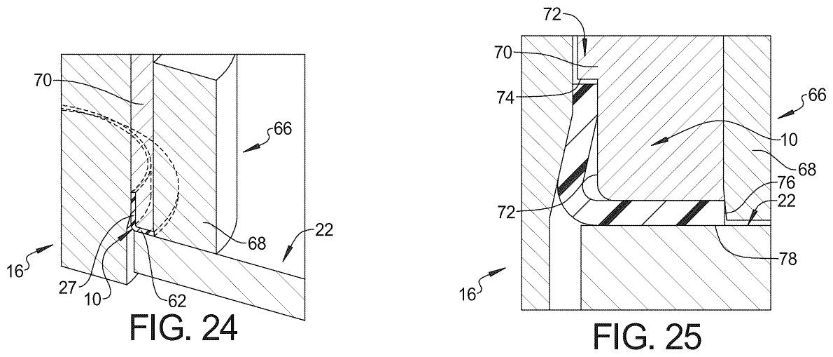

In FIGS. 24 and 25, the moveable sleeve 70 is moved further downward relative to the fixed sleeve 68. As a result, the lip 62 of the collar 10 has further deflected downward, and the inboard end 28 of the annular body 27 of the collar 10 has further deflected radially inward. In turn, the lip 62 forms an acute angle with the annular body 27 adjacent to the fillet 64, and the lip 62 forms a right angle with the annular body adjacent to the outboard end 30. As a result, the taper angle of the inner radial surface 32 of the collar 10 matches the taper angle of the tapered portion 44 of the shaft 16.

Thus, as in the previous examples, the engagement between these tapered surfaces prevents separation of the collar 10 from the housing 12. Also, the bottom surface 78 of the lip 62 may have the serrations that penetrate the one end cap 22 and thereby prevent separation of the collar 10 from the housing 12 as in the previous examples.

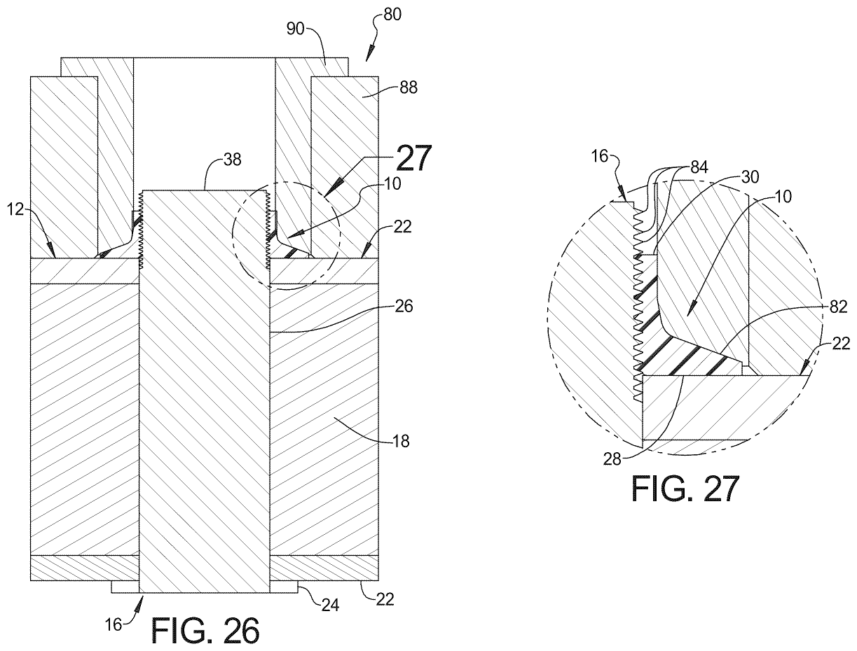

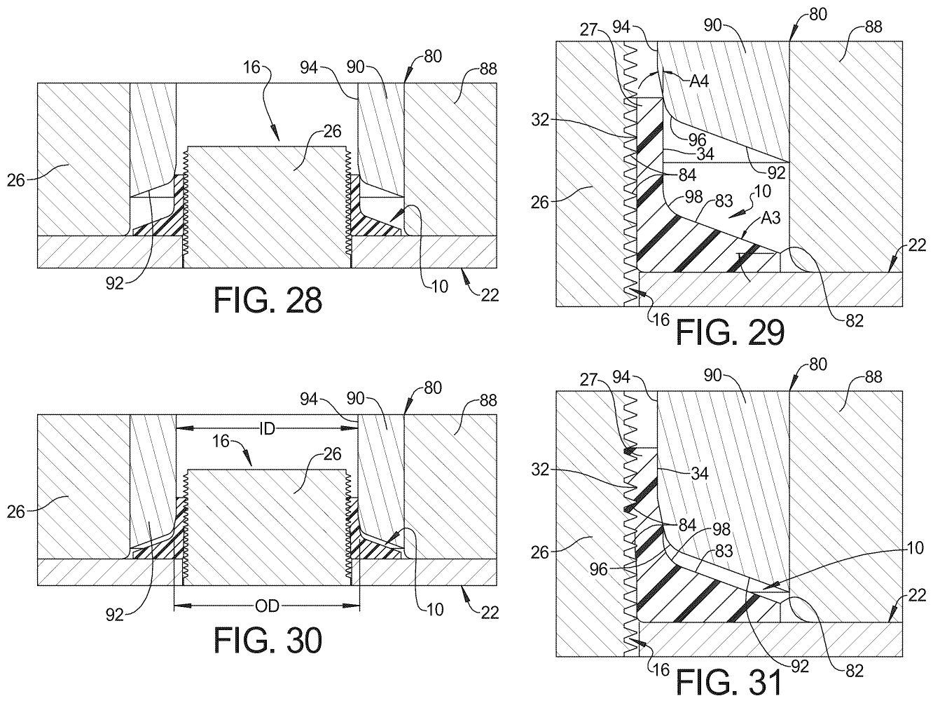

Referring to FIGS. 26 through 35, another example of the collar 10 is illustrated. FIGS. 26 and 27 show the collar 10 crimped to the shaft 16 and a crimping tool 80 around the collar 10, and FIGS. 28 through 35 show how the crimping tool 80 crimps the collar 10 to the shaft 16. As with the previous examples, the collar 10 shown in FIGS. 26 and 27 has the annular body 27 with the inboard end 28, the outboard end 30, the inner radial surface 32, and the outer radial surface 34. In addition, the shaft 16 has the head 24 and the shank 26, and the collar 10, once crimped to the shaft 16, abuts one of the end caps 22 such that the windings 18 are held between the end caps 22.

In contrast to the previous examples, the collar 10 shown in FIGS. 26 and 27 includes a ramped base 82 projecting radially from the annular body 27 at the inboard end 28 of the collar 10. The ramped base 82 includes a tapered portion 83 that is tapered inward at an angle A3 (FIG. 29) in a direction from the inboard end 28 of the collar 10 to the outboard end 30 of the collar 10. Also, in contrast to the previous examples, the collar 10 is crimped to the shaft 16 by applying both an axial load and a diametrical load to the collar 10, although a moveable sleeve 90 of the crimping tool 80 moves in only one direction along the axis of the shaft 16 during crimping consistent with previous examples. In addition, the inner radial surface 32 of the collar 10 has little to no taper, and the outer radial surface 34 of the collar 10 is tapered inward in a direction from the inboard end 28 of the collar 10 to the outboard end 30 of the collar 10. Furthermore, the shank 26 of the shaft 16 has annular ribs 84 extending around the circumference of the shank 26 and spaced apart from one another in an axial direction along the length of the shaft 16.

FIGS. 28 through 35 show how the collar 10 of FIGS. 26 and 27 may be crimped to the shaft 16 by applying both an axial load and a diametrical load to the outer radial surface 34 of the collar 10 while the moveable sleeve 90 of the crimping tool 80 moves in only one direction along the axis of the shaft 16. FIGS. 28 and 29 shows the collar 10 in its pre-crimped state, with the collar 10 slid over the distal end 38 of the shaft 16 and resting on one end cap 22, and the crimping tool 80 surrounding the outboard end 30 of the collar 10. The crimping tool 80 includes a fixed sleeve 88 and the moveable sleeve 90 that is axially moveable relative to the fixed sleeve 88. The moveable sleeve 90 has an end surface 92 that is tapered at an angle matching the taper angle A3 of the ramped base 82 of the collar 10, an inner radial surface 94 that is tapered at an angle A4, and a curved surface 96 that provides a transition between the end surface 92 and the inner radial surface 94. The taper angle A4 may be selected to yield a desired ratio between the axial and diametrical loads applied to the collar 10. In one example, the taper angle A4 is less than 30 degrees (e.g., 10 degrees).

In FIGS. 30 and 31, the moveable sleeve 90 of the crimping tool 80 has moved in the axial direction from its position shown in FIGS. 28 and 29 toward the ramped base 82 of the collar 10. The moveable sleeve 90 has an inner diameter ID that is less than an outer diameter OD of the annular body 27 of the collar 10 in its pre-crimped state to yield an interference fit therebetween. Thus, as the moveable sleeve 90 moves in the axial direction toward the ramped base 82 of the collar 10, the inner radial surface 94 of the moveable sleeve 90 applies a diametrical load to the outer radial surface 34 of the collar 10. In turn, the annular body 27 of the collar 10 deforms radially inward toward the shank 26 of the shaft 16 and between the annular ribs 84 on the shank 26, and the annular ribs 84 bite into the inner radial surface 32 of the collar 10. In addition, due to the taper angle A4 of the inner radial surface 94 on the moveable sleeve 90, the moveable sleeve 90 applies an axial load to the outer radial surface 34 of the collar 10. As a result, the annular body 27 of the collar 10 elongates in the axial direction toward the ramped base 82 of the collar 10, and therefore the ramped base 82 presses against the one end cap 22 to tightly secure the windings 18 between the end caps 22.

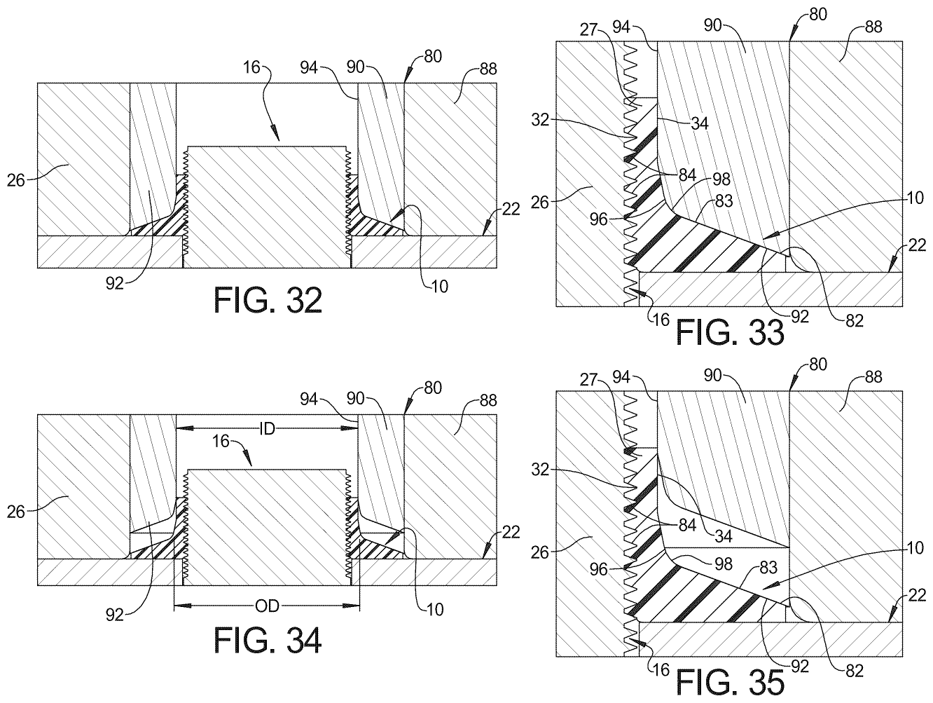

In FIGS. 32 and 33, the moveable sleeve 90 of the crimping tool 80 has moved in the axial direction into contact with the ramped base 82 of the collar 10, and the collar 10 is in its crimped state. Due to the axial and radial deformation of the annular body 27 of the collar 10, the outer radial surface 34 of the collar 10 conforms to the inner radial surface 94 of the moveable sleeve 90 when the moveable sleeve 90 has reached the position shown. In addition, the ramped base 82 of the collar 10 conforms to the end surface 92 of the moveable sleeve 90. Further, the collar 10 has a curved surface 98 that provides a transition from its outer radial surface 34 to its ramped base 82, and the curved surface 98 conforms to the curved surface 96 of the moveable sleeve 90.

In FIGS. 34 and 35, the moveable sleeve 90 of the crimping tool 80 has moved in the axial direction in a direction away from the ramped base 82 of the collar 10. Although the moveable sleeve 90 is no longer in contact with the ramped base 82 of the collar 10, the collar 10 is not allowed to move axially away from the one end cap 22 due to the engagement between the annular ribs 84 on the shaft 16 and the annular body 27 of the collar 10. Thus, the ramped base 82 of the collar 10 continues to press against the one end cap 22 to tightly secure the windings 18 between the end caps 22.

The annular ribs 86 and the moveable sleeve 90 are made from material(s) that is/are harder than the material from which the collar 10 is made so that the collar 10 deforms instead of the annular ribs 86 or the moveable sleeve 90. While the drawings show certain dimensions, the present disclosure encompasses embodiments that vary from those dimensions by, for example, as much as plus or minus 10 percent (e.g., for the collar size shown). The dimensions on the drawings are in millimeters (mm) unless specified otherwise.

The dimensions of the collar 10, the shaft 16, and the moveable sleeve 90 may be balanced to obtain a reasonable load for assembly while creating enough interference between the collar 10 and the shaft 16 to yield a desired clamp load. For example, in the example shown, the collar 10 has a wall thickness of 3 mm. However, the wall thickness of the collar 10 may vary based on the material of the collar 10 and the design of the crimping tool 80. In an example of the latter, the wall thickness of the collar 10 may be adjusted based on the taper angle A4 of the inner radial surface 94 of the moveable sleeve 90. In addition, the strength of the collar 10 and the annular ribs 84 on the shaft 16 may be considered to ensure that the collar 10 and the annular ribs 84 are not damaged as the collar 10 is crimped.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “and/or” includes any and all combinations of one or more of the listed items, and the phrase “at least one of A, B, and C” should be construed to mean “A OR B OR C”, using a non-exclusive logical OR, and should not be construed to mean “at least one of A, at least one of B, and at least one of C.”

What is claimed is:

1. An electric rotor comprising:
a shaft including a head and a shank;
windings extending around the shank of the shaft;
a first end cap having a first side engaging a first end of the windings and a second side engaging the head of the shaft;
a second end cap having a first side engaging a second end of the windings opposite of the first end; and
a collar crimped to the shank of the shaft and engaging a second side of the second end cap opposite of the first side of the second end cap such that (i) the windings are clamped between the first and second end caps and (ii) the shaft, the windings, the first and second end caps, and the collar rotate together as a single unit, wherein a portion of the shank to which the collar is crimped is not slotted relative to the rest of the shank.

2. The electric rotor of claim 1 wherein the collar includes serrations that penetrate the second side of the second end cap.

3. The electric rotor of claim 1 wherein the shaft has a tapered outer radial surface and the collar has a tapered inner radial surface that engages the tapered outer radial surface of the shaft.

4. The electric rotor of claim 3 wherein the tapered outer radial surface of the shaft is tapered inward in a direction toward the head of the shaft, and the tapered inner radial surface of the collar is tapered inward in the same direction.

5. The electric rotor of claim 1 wherein the collar includes an annular body and a lip projecting radially from the annular body.

6. The electric rotor of claim 1 wherein the collar includes an annular body and a ramped base projecting radially from the annular body.

7. An electric rotor comprising:
a shaft including a head and a shank;
windings extending around the shank of the shaft;
a first end cap having a first side engaging a first end of the windings and a second side engaging the head of the shaft;
a second end cap having a first side engaging a second end of the windings opposite of the first end; and
a collar crimped to the shank of the shaft and penetrating a second side of the second end cap opposite of the first side of the second end cap such that (i) the windings are clamped between the first and second end caps and (ii) the shaft, the windings, the first and second end caps, and the collar rotate together as a single unit.

8. A method of assembling an electric rotor, the method comprising:
sliding a first end cap along a shank of a shaft until the first end cap engages a head of the shaft;
sliding windings onto the shaft;
sliding a second end cap onto the shaft such that the windings are disposed between the first and second end caps;
sliding a collar onto the shaft; and
crimping the collar onto the shaft and pressing the collar against the second end cap in a single operation such that (i) the windings are clamped between the first and second end caps and (ii) the shaft, the windings, the first and second end caps, and the collar rotate together as a single unit.

9. The method of claim 8 further comprising both crimping the collar onto the shaft and pressing the collar against the second end cap by moving a crimping tool in a single direction.

10. The method of claim 9 wherein the single direction is a radial direction relative to the shaft.

11. The method of claim 9 wherein the single direction is along a longitudinal axis of the shaft.

12. The method of claim 8 further comprising applying a diametrical load to the collar to engage a tapered inner radial surface of the collar with a tapered outer radial surface of the shaft and thereby both crimp the collar onto the shaft and press the collar against the second end cap.

13. The method of claim 12 wherein pressing the collar against the second end cap causes serrations on an axial end of the collar to penetrate the second end cap.

14. The method of claim 8 wherein the collar includes an annular body and a lip projecting radially from the annular body, the method further comprising applying an axial load to the annular body to both crimp the collar onto the shaft and press the collar against the second end cap.

15. The method of claim 14 wherein an angle between the lip and the annular body is obtuse before the collar is crimped, the method further comprising applying the axial load to an axial end of the annular body with a moveable sleeve of a crimping tool while engaging an outer edge of the lip with a fixed sleeve of the crimping tool to decease the angle between the lip and the annular body.

16. The method of claim 8 wherein the collar includes an annular body and a lip projecting radially from the annular body, the method further comprising applying a diametrical load to the lip to both crimp the collar onto the shaft and press the collar against the second end cap.

17. The method of claim 16 wherein an angle between the lip and the annular body is acute before the collar is crimped, the method further comprising receiving the annular body in an annular pocket in a moveable sleeve of a crimping tool while applying the diametrical load to an outer edge of the lip with the moveable sleeve to increase the angle between the lip and the annular body.

18. The method of claim 8 wherein the collar includes an annular body and a ramped base projecting radially from the annular body, the method further comprising applying both an axial load and a diametrical load to the collar to both crimp the collar onto the shaft and press the collar against the second end cap.

19. The method of claim 18 further comprising engaging a tapered inner surface of a crimping tool with an outer radial surface of the annular body of the collar while moving the crimping tool in an axial direction to apply the axial and diametrical loads to the collar and thereby deform the collar radially inward toward the shaft and axially toward the second end cap.

20. The method of claim 19 further comprising moving the crimping tool in the axial direction until a tapered end surface of the crimping tool engages the ramped base of the collar, wherein a taper angle of the tapered end surface of the crimping tool matches a taper angle of the ramped base of the collar.
